(19) United States
(12) Patent Application Publication
(10) Pub. No.: US 2026/0163422 A1
(43) Pub. Date: Jun. 11, 2026

(54) ROTOR OF AN ELECTRIC MACHINE

(71) Applicant: Robert Bosch GmbH, Stuttgart (DE)

(72) Inventors: Andreas Herzberger, Remseck Am Neckar (DE); Benedikt Lahl, Peine (DE); Christian Prag, Stuttgart (DE); Christoph Hammer, Marbach (DE); Claus-Christian Oetting, Blaichach (DE); Florian Herzog, Bad Hindelang (DE); Harald Laue, Esslingen (DE); Konstantin Lindenthal, Blaichach (DE); Manuel Gaertner, Burgstetten (DE); Niklas Schroeder, Giesen (DE)

(21) Appl. No.: 18/710,374

(22) PCT Filed: Nov. 7, 2022
(86) PCT No.: PCT/EP2022/080926

§ 371 Date: May 15, 2024

(30) Foreign Application Priority Data
Nov. 18, 2021 (DE) 10 2021 212 953.6

(51) Int. Cl. H02K 1/27

(52) U.S. Cl. CPC H02K 1/27

(57) ABSTRACT

Rotor of an electric machine, comprising a rotor body (3) rotatable about a rotor axis (2), comprising a plurality of rotor poles (4) each with a pole center (5), wherein the rotor body (3) comprises a rotor main body (8) which at its outer periphery has a plurality of indentations (9), which are distributed over the outer periphery and into each of which at least one magnet (10), in particular permanent magnet, and a separate pole segment (11) are inserted in order to form one of the rotor poles (4), a V-shaped, U-shaped or arcuate magnet pocket (12) being formed between each pole segment (11) and the corresponding indentation (9) in the rotor main body (8) said magnet pockets each having two pocket openings (15) towards the outer periphery of the rotor body (3) and serving to receive the at least one magnet (10), the rotor body (3) being enclosed by a rotor sleeve (16), characterized in that the rotor sleeve (16) is a cured fiber-composite bandage, the matrix material (16.1) of which, during the production of tire fiber-composite bandage (16), is penetrated via the respective pocket openings (15) into at least one, in particular all of the magnet pockets (12) of the rotor body (3) in order to fasten the particular magnet (10) of the particular magnet pocket (12) to the rotor main body (8) and/or to the particular pole segment (11).

### BACKGROUND

The invention proceeds from a rotor of an electric machine of the type specified in the disclosure.

A rotor of an electric machine is already known from US2020266677 A, with a rotor body rotatable about a rotor axis and comprising a plurality of rotor poles each having a pole center, wherein the rotor body has a rotor main body which has on its outer periphery a plurality of indentations distributed over the outer periphery, in each of which recesses two magnets and a separate pole segment are inserted to form one of the rotor poles. A V-shaped, U-shaped, or arcuate magnet pocket is formed between the respective pole segment and the respective indentation of the rotor main body, each of which has two pocket openings towards the outer periphery of the rotor body and serves to receive the two magnets. The rotor body is enclosed by a rotor sleeve.

### SUMMARY

In contrast, the rotor of an electrical machine according to the disclosure has the advantage that the fastening of the magnets in the magnetic pockets is improved in that the rotor sleeve is a cured fiber-composite bandage, the matrix material of which has penetrated into at least one, in particular all, of the magnetic pockets of the rotor body via the respective pocket openings during the manufacture of the fiber-composite bandage for the adhesive or material-locking fastening of the respective magnet of the respective magnetic pocket to the rotor main body and/or to the respective pole segment.

The matrix material, which is still liquid, for example in excess, runs or drips into the respective magnet pocket during the production, for example a wet winding process, of the fiber-composite bandage, for example gravity-driven and/or is drawn into gaps formed between the respective magnet and the respective separate pole segment or between the respective magnet and the rotor main body, for example by capillary action. The penetration of the matrix material into the gap can improve the thermal connection of the magnets to the rotor main body and/or the pole segments and thus the cooling of the magnets. The matrix material can also improve the insulation of the magnets from the rotor body.

It is particularly advantageous if a gap is provided in one or a plurality of, in particular in all, of the magnet pockets on an upper side of the respective magnet facing the respective pole segment and/or on an underside of the respective magnet opposite the upper side, which is at least partially filled with the matrix material. In this way, the matrix material of the fiber-composite bandage is also used to fasten and cool the magnets.

It is also advantageous if a gap is provided in the respective magnet pocket between the fiber-composite bandage and a narrow side of the respective magnet facing the fiber-composite bandage. This avoids eddy currents at the air gap and thus reduces electromagnetic losses.

It is very advantageous if the at least one magnet of the respective magnetic pocket is pre-fixed to a joining surface of the rotor main body and/or to a joining surface of the respective pole segment in each case by means of an adhesive bond, in particular an adhesive coating or an adhesive film. In this way, the pole segments can be pre-fixed to the rotor main body so that the so-called wet winding of the fiber composite bandage can then take place. This ensures that the pole segments and the rotor main body form a single unit during wet winding.

The adhesive bond also means that less matrix material is needed to fill the gap, so that less matrix material is required for wet winding. In addition, the magnets can be completely insulated from the laminations of the rotor main body or the respective pole segment by the adhesive coating or adhesive film of the adhesive bond, so that fewer electromagnetic losses occur.

It is also advantageous if the adhesive bond has a structure, in particular a surface and/or hollow structure, for passing the matrix material of the fiber composite bandage along a surface of the respective magnet towards the respective pole center. This ensures that the matrix material can at least partially fill the gap despite the pre-fixing adhesive bond. For example, the magnets are encased in the matrix material, which can improve the insulation of the magnets from the rotor body.

According to an advantageous embodiment, the fiber composite bandage is designed to be magnetically non-conductive and comprises fibers embedded in the matrix material, in particular carbon fibers or glass fibers. This creates a functional separation in the rotor, wherein the rotor body conducts the magnetic flux and the fiber composite bandage meets the mechanical requirements in terms of speed stability. The fiber composite bandage eliminates the need for stray bars or bridges. In addition, air gaps, which have to be provided in the prior art due to joining tolerances when joining the magnets, can be omitted.

It is advantageous if the respective indentation of the rotor main body and the respective pole segment are circular sector-shaped, as in this way the V-shaped, U-shaped, or arcuate magnetic pockets are formed as a layered intermediate space between the rotor main body and the respective pole segment.

It is also advantageous if the legs of the magnetic pocket are each arranged at an angle to the center of the pole, in particular symmetrically to the center of the pole and in particular diverging towards the outer periphery. In this way, an advantageous magnet arrangement is achieved in terms of performance and efficiency.

According to a further advantageous embodiment, it is provided that the rotor main body is a laminated core and/or that the respective pole segment is a laminated core or a soft magnetic composite (SMC) body. With a pole segment made of soft magnetic composite (SMC), eddy current losses in any spatial direction can be avoided.

The invention can also relate to an electrical machine with a rotor according to the invention.

### BRIEF DESCRIPTION OF THE DRAWINGS

An exemplary embodiment of the invention is shown in simplified form in the drawing and explained in more detail in the following description.

FIG. 1 shows a rotor of an electric machine according to the invention and

FIG. 2 a detailed view of the rotor according to FIG. 1.

### DETAILED DESCRIPTION

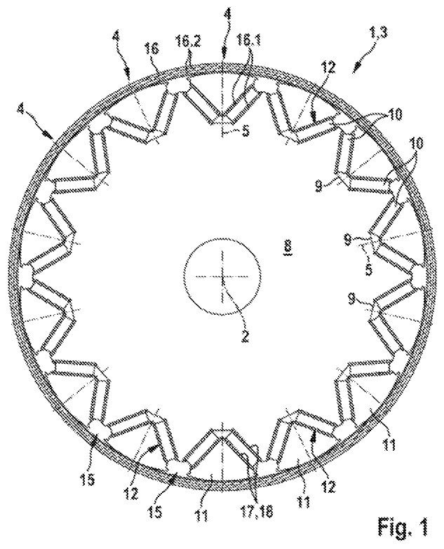

FIG. 1 shows a rotor of an electric machine according to the invention.

The rotor 1 of the electric machine has a rotor body 3 rotatable about a rotor axis 2 and comprises a plurality of rotor poles 4, each with a pole center 5.

The rotor body 3 has a rotor main body 8, which has a plurality of indentations 9 on its outer periphery distributed around its outer periphery, into each of which at least one magnet 10, for example two magnets 10 and a separate pole segment 11, is inserted to form one of the rotor poles 4. The magnet 10 is a permanent magnet, for example.

The rotor main body 8 is a stack of laminations, for example. The respective pole segment 11 can also be a laminated core or alternatively a soft magnetic composite (SMC) body.

A V-shaped, U-shaped, or arcuate magnet pocket 12 is formed between the respective pole segment 11 and the respective indentation 9 of the rotor main body 3, each of which has two pocket openings 15 towards the outer periphery of the rotor body 3 and serves to receive the at least one magnet 10. The respective indentation 9 of the rotor main body 8 and the respective pole segment 11 are designed in the shape of a circular sector, for example.

The legs of the V-shaped, U-shaped, or arcuate magnetic pocket 12 are each arranged at an angle α to the pole center 5, for example symmetrically to the pole center 5 and diverging towards the outer periphery, for example.

The rotor body 3 is enclosed by a rotor sleeve 16, in particular to increase the speed stability of the rotor 1. The pocket openings 15 are concealed or covered by the rotor sleeve 16.

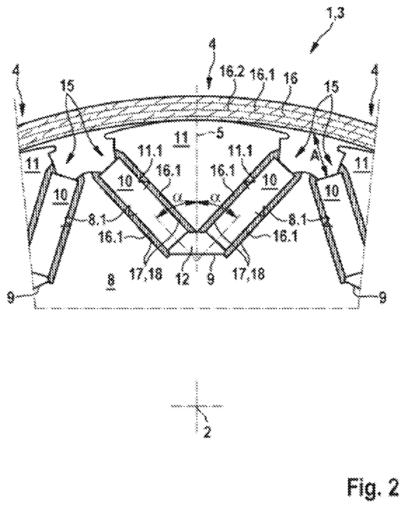

FIG. 2 shows a detailed view of the rotor according to FIG. 1.

According to the invention, it is provided that the rotor sleeve 16 is a cured fiber composite bandage, the matrix material 16.1 of which has penetrated into at least one, in particular all, of the magnetic pockets 12 of the rotor body 3 via the respective pocket openings 15 during the manufacture of the fiber composite bandage 16 for fastening the respective magnet 10 of the respective magnetic pocket 12 to the rotor main body 8 and/or to the respective pole segment 11.

The matrix material, which is still liquid, for example excessively dosed, runs or drips into the respective magnetic pocket 12 during the production, for example a wet winding process, of the fiber composite bandage 16, for example gravity-driven and/or by capillary action. During wet winding of the fiber composite bandage, a fiber wetted with the matrix material 16.1 is wound onto the rotor body 3, forming a fiber winding with a plurality of winding layers, for example. The upper winding layers of the forming fiber composite contribute to pressing the matrix material 16.1 in the direction of the magnetic pockets 12 by exerting corresponding pressure on the winding layers below.

The matrix material 16.1 can be cured during the manufacture of the fiber composite bandage 16, for example by means of UV radiation for pre-curing and by means of heat for complete curing.

The fiber composite bandage 16 is magnetically non-conductive and comprises fibers 16.2, for example carbon fibers or glass fibers, embedded in the matrix material 16.1. The respective pole segment 11 is fastened to the rotor main body 8 without scattering by means of the matrix material 16.1 of the fiber composite bandage 16 indirectly via the at least one magnet 10.

In one or a plurality of, in particular in all, of the magnet pockets 12, a gap 17 is provided on an upper side of the respective magnet 10 facing the respective pole segment 11 and/or on an underside of the respective magnet 10 opposite the upper side, which gap is at least partially filled with the matrix material 16.1.

In the respective magnet pocket 12, a distance A is provided between the fiber composite bandage 16 and a narrow side of the respective magnet 10 facing the fiber composite bandage 16.

The at least one magnet 10 of the respective magnet pocket 12 is pre-fixed or attached to a joining surface 8.1 of the rotor main body 8 and/or to a joining surface 11.1 of the respective pole segment 11 in each case by means of an adhesive bond 18, for example a double-sided adhesive coating or an adhesive film. The adhesive bond 18 can, for example, have a structure, in particular a surface and/or hollow structure, for passing the matrix material 16.1 of the fiber composite bandage 16 along a surface of the respective magnet 10 towards the respective pole center 5.

1. A rotor (1) of an electric machine, comprising a rotor body (3) rotatable about a rotor axis (2), plurality of rotor poles (4) each with a pole center (5), wherein the rotor body (3) has a rotor main body (8) which at its outer periphery has a plurality of indentations (9), which are distributed over the outer periphery and into each of which at least one magnet (10) and a separate pole segment (11) are inserted to form one of the rotor poles (4), wherein a V-shaped, U-shaped, or arcuate magnet pocket (12) is formed between each pole segment (11) and the corresponding indentation (9) in the rotor main body (8), said magnet pockets each having two pocket openings (15) toward the outer periphery of the rotor body (3) and serving to receive the at least one magnet (10), wherein the rotor body (3) is enclosed by a rotor sleeve (16), wherein
the rotor sleeve (16) is a cured fiber-composite bandage, matrix material (16.1) of which, during production of the fiber-composite bandage (16), is penetrated via the respective pocket openings (15) into at least one, of the magnet pockets (12) of the rotor body (3) to fasten the respective magnet (10) of the respective magnet pocket (12) to the rotor main body (8) and/or to the respective pole segment (11).

2. The rotor according to claim 1, wherein a gap (17) is provided in one or a plurality of the magnet pockets (12) on an upper side of the respective magnet (10) facing the respective pole segment (11) and/or on an underside of the respective magnet (10) opposite the upper side, which gap is at least partially filled with the matrix material (16.1).

3. The rotor according to claim 1, wherein a gap (A) is provided in the respective magnet pocket (12) between the fiber-composite bandage (16) and a narrow side of the respective magnet (10) facing the fiber-composite bandage (16).

4. The rotor according to claim 1, wherein the at least one magnet (10) of the respective magnet pocket (12) is pre-fixed to a joining surface (8.1) of the rotor main body (8) and/or to a joining surface (11.1) of the respective pole segment (11) by means of an adhesive bond (18).

5. The rotor according to claim 4, wherein the adhesive bond (18) has a structure for passing the matrix material (16.1) of the fiber-composite bandage (16) along a surface of the respective magnet (10) towards the respective pole center (5).

6. The rotor according to claim 1, wherein the fiber-composite bandage (16) is configured to be magnetically non-conductive and comprises fibers (16.2) embedded in the matrix material (16.1).

7. The rotor according to claim 1, wherein the respective indentation (9) of the rotor main body (8) and the respective pole segment (11) are configured in a shape of a circular sector.

8. The rotor according to claim 1, wherein legs of the magnetic pocket (12) are each arranged at an angle (α) to the pole center (5).

9. The rotor according to claim 1, wherein the rotor main body (8) is a laminated core and/or the respective pole segment (11) is a laminated core or a soft magnetic composite (SMC) body.

10. An electric machine with a rotor (1) according to claim 1.

11. The rotor according to claim 1, wherein the at least one magnet (10) is a permanent magnet.

12. The rotor according to claim 1, wherein the matrix material (16.1) is penetrated via the respective pocket openings (15) into all of the magnet pockets (12) of the rotor body (3).

13. The rotor according to claim 2, wherein the gap (17) is provided in all of the magnet pockets (12).

14. The rotor according to claim 4, wherein the adhesive bond (18) is an adhesive coating or an adhesive film.

15. The rotor according to claim 5, wherein the structure includes a surface and/or hollow structure for passing the matrix material (16.1) of the fiber-composite bandage (16) along the surface of the respective magnet (10) towards the respective pole center (5).

16. The rotor according to claim 6, wherein the fibers (16.2) include carbon fibers or glass fibers.

17. The rotor according to claim 8, wherein the legs of the magnetic pocket (12) are each arranged symmetrically to the pole center (5).

18. The rotor according to claim 8, wherein the legs of the magnetic pocket (12) are diverging towards the outer periphery.
